(19) United States
(12) Patent Application Publication
(10) Pub. No.: US 2026/0348734 A1
(43) Pub. Date: Nov. 5, 2026

(54) DETERMINING VEHICLE OPERATING AREA

(71) Applicant: Zoox, Inc., Foster City, CA (US)

(72) Inventors: Ajinkya Sanjay Khade, San Francisco, CA (US); Kai Zhenyu Wang, San Mateo, CA (US)

(21) Appl. No.: 19/195,037

(22) Filed: Apr. 30, 2025

(51) Int. Cl. G01C 21/34; G01C 21/00

(52) U.S. Cl. CPC G01C 21/3461; G01C 21/3811; G01C 21/3822

(57) ABSTRACT

Techniques for determining an operating area are described herein. An expansion component may receive map data that includes data representing objects within the environment. The expansion component may discretize the map data into discretized regions of the environment. The expansion component may identify the attributes along the discretized region (e.g., road segment) and cluster the road segments based on the attributes. For each cluster, the expansion component may determine a metric that measures the capability of the vehicle to navigate the road segments within the cluster. For clusters with a metric that are below a threshold value, the expansion component may determine a cost of modifying vehicle systems to increase the metric to a value that meets or exceeds the threshold value. Based on the cost and/or metric values, the expansion component may determine cluster(s) of road segment(s) to include in an operating area for a fleet of vehicle(s).

### BACKGROUND

Vehicles, such as autonomous vehicles, may operate and/or provide services within a specified region (e.g., geofence). However, in certain circumstances, techniques for determining the size of the operation region, when to expand the operation region, and/or where to expand the operation region may result in inaccurate results and/or suboptimal operation regions, thereby leading to a suboptimal passenger experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram illustrating an example technique for expanding operating area(s) for a vehicle, in accordance with one or more examples of the disclosure.

FIG. 2 illustrates an example computing system including an expansion component configured to determine expanded operating regions for a fleet of vehicles to operate within, in accordance with one or more examples of the disclosure.

FIG. 3 depicts an example environment including discretized regions of the environment with various attributes, in accordance with one or more examples of the disclosure.

FIG. 4 depicts an example environment including an operating region and/or expanded operating regions, in accordance with one or more examples of the disclosure.

FIG. 5 depicts a block diagram of an example system for implementing various techniques described herein.

FIG. 6 is a flow diagram illustrating an example process for receiving discretized regions of the environment, determining attributes of the discretized regions, determining a metric of the discretized region based on the attributes, determining a cost based on the metric, and determining an operating area based on the cost, in accordance with one or more examples of the disclosure.

### DETAILED DESCRIPTION

Techniques for determining a vehicle operating area are described herein. In some examples, a fleet expansion component may receive map data that includes data representing the static objects within the environment (e.g., type data, location data, size data, orientation data, etc.). The fleet expansion component may discretize the map data into discretized regions of the environment. That is, in this example, a discretized region may be a road segment (e.g., one or more driving lanes of equal length associated with the same direction of travel). In some cases, the fleet expansion component may identify the attributes (e.g., school zones, traffic lights, crosswalks, fire hydrants, junctions, parking space data, etc.) along the road segment (or discretized region) and cluster the road segments based on similarity in attributes. For each cluster, the fleet expansion component may determine a metric that measures the ability and/or capability of the autonomous vehicle to navigate the road segments within the cluster. For clusters with a metric that is below a threshold value (e.g., the autonomous vehicle experiences difficulty navigating the road segments within the cluster), the fleet expansion component may determine a cost for modifying the vehicle software and/or hardware to increase the metric to a value that meets or exceeds the threshold value. Based on the cost and/or metric values, the fleet expansion component may determine cluster(s) of road segment(s) to include in an operating area for a fleet of vehicle(s). As described in more detail below, the techniques described herein may improve vehicle safety and/or driving efficiency by increasing the accuracy in assessing which regions of the environment the autonomous vehicles may safely and/or effectively navigate.

When determining where and/or how to deploy a fleet of vehicles within an environment, it may be beneficial to consider attributes within the environment. For example, a fleet of vehicles may provide services (e.g., taxi service, delivery service, etc.) within a specified geofence (e.g., a virtually bounded geographic region). In some cases, a company or manager of the fleet may intend to expand and/or modify the geofence such that the vehicles service a larger, modified, and/or expanded region. However, in some circumstances, it may be difficult to predict when the vehicle is capable of servicing a new region of the environment and/or where to expand the geofence. For example, a fleet of vehicles may expand geofences when the number of vehicles increases, the demand increases, the capabilities of the vehicle(s) to properly handle attributes in the environment increases, etc. In some cases, the capabilities of the vehicle may be inaccurately analyzed which may result in deploying the fleet of vehicle(s) to service an expanded geofence with new and/or different geographic attributes which may result in the vehicle failing to properly service the expanded geofence. Inadequate service of an environment may result in suboptimal pedestrian and/or occupant experience with the vehicle. As such, the systems and/or techniques described herein may increase the ability of a system to deploy fleets of vehicles to regions of an environment that the vehicles can properly and/or effectively service (or navigate).

To address these and other technical problems and inefficiencies, the systems and/or techniques described herein include an expansion component (which also may be referred to as an “expansion system” or “fleet expansion component”) configured to generate expanded operation regions for fleets of autonomous vehicles by leveraging similarity data associated with discretized regions of the environment. Technical solutions discussed herein solve one or more technical problems associated with conventional operating area expansion techniques resulting in a suboptimal operating area.

In some examples, the expansion component may receive map data. Map data may include any number of data structures, modeled in two or more dimensions that are capable of providing information about the environment, such as, but not limited to, road network data, topologies, intersections, streets, roads, terrain, emergency zone(s), school zone(s), and the environment in general. The map data may also represent various map features within the environment along the route, including but not limited to roads (e.g., road segment data), lanes (e.g., lane segment data), curbs, shoulders, crosswalks, buildings, medians, street signs, traffic signs, speed limits, etc.

In some examples, the expansion component may generate discretized map data based on the map data. Discretized map data may include discretized or sectioned portions (or regions) of the environment. In some examples, a discretized region (or the discretized unit) may be a road segment (e.g., one or more driving lanes of equal length associated with the same direction of travel). That is, each road segment in the map data may be a discretized region. In some examples, a road segment (e.g., discretized region) may include one or more attributes (or environmental features) such as school zone(s), emergency zone(s) (e.g., hospitals, fire stations, etc.), steep gradient(s), roundabouts, fire hydrant(s), traffic light(s), etc.

In some examples, the expansion component may determine (or identify) the attributes of the road segment(s) (e.g., discretized region). The expansion component may use various techniques to determine the attributes such as by manually analyzing the map data, by using machine-learned model(s) to output the attributes, and/or by using third-party data. That is, in some cases, the attributes may be labeled, tagged, and/or annotated in the map data. As such, the expansion component may identify the labeled attribute(s) in the map data that are located along the road segment(s). Additionally or alternatively, the expansion component may input the map data and/or the road segment into a machine-learned model which may be trained to identify the attributes along the road segments. In this case, the machine-learned model may output a list of the one or more attributes associated with a specific road segment. Additionally or alternatively, the expansion component may leverage third-party data such as city maps, organization maps, etc. to assist in identifying attribute(s) along the road segment.

In some examples, the expansion component may determine cluster(s) of road segment(s) (e.g., discretized region) based on the similarity of the attributes between road segment(s). A cluster may include one or more road segments or discretized regions. The expansion component may determine the cluster(s) based on a similarity between the road segments. The similarity between road segments may be a similarity between attributes of the road segments. As an example, a first cluster may include road segments that have school zone(s), a second cluster may include road segments that have similar, steep gradients, etc. In some cases, the expansion component may determine the clusters using heuristic-based techniques and/or using machine-learned techniques. For example, the expansion component may generate an embedding associated with a road segment by inputting the road segment and the associated attribute(s) into a machine-learned model. An embedding may be a structured form of representing the road segment and the associating attributes. In this example, the expansion component may use the embeddings of the road segments to determine similarity between road segments. That is, the expansion component may compare embeddings (e.g., determine distances between values of the embeddings) to determine a similarity score between road segments and include road segments with a threshold level of similarity scores into the same cluster. Additionally or alternatively, the expansion component may determine the similarity score by comparing an embedding of a road segment to a representative embedding of a cluster embedding (e.g., embedding for a cluster of road segments that are in an original operating area). In such cases, the comparison may result in a similarity score which the expansion component may use to perform the clustering.

Based on generating the cluster(s), the expansion component may determine a metric of the cluster. The metric may represent or measure the capability (or ability) of an autonomous vehicle to navigate a road segment within the cluster. That is, the metric may indicate the challenges of navigating the road segment autonomously based on the attributes associated with the road segment. In some examples, the expansion component may determine the metric by analyzing log data and/or simulation data.

For example, the expansion component may retrieve log data from a database. Log data may comprise, for example, sensor data acquired from one or more sensors, derivative data (e.g., perception data determined based on such sensor data), component status messages (e.g., battery state or charge, brake function, etc.), planner and control data, and any other message transmitted while the vehicle is in operation. Further, log data may include one or more driving scenarios captured and/or experienced by a vehicle at a previous time. A driving scenario may include the associated map data, vehicle (or vehicle representation) information (e.g., trajectory data (e.g., velocity, acceleration, steering angle, etc.), pose data, etc.), object information (e.g., a trajectory of the object(s), a pose of the object(s), a number of object(s), a type of the object(s) (e.g., vehicle (e.g., small car, semi-truck, etc.), pedestrian, animal, cyclist, etc.), a past trajectory of the object(s), etc.), speed limit data, a number of lanes, a type of lane marker, environmental data (e.g., time of day, visibility, amount of sunlight, weather conditions (e.g., rain, snow, ice, etc.), etc.) of the environment, a vehicle software version (e.g., software version the vehicle used when the data was captured), sensor data (e.g., lidar data, radar data, image data, etc.) and/or the times at which such sensor data was captured, and/or any other information. The expansion component may identify driving scenarios from the log data that include road segments similar to those in the cluster (e.g., road segment including the same or similar attributes). Based on receiving the driving scenario, the expansion component may simulate (or perform a simulation operation on) the driving scenario. Based on the simulation, the expansion component may receive simulation data which may be data about the simulation. In some examples, the expansion component may analyze the simulation data to determine the metric.

For example, the expansion component may determine the metric based on the simulation data. The simulation data may include factors that may impact the metric. For example, factors may include the number of disengagements (e.g., high numbers of disengagement may indicate an inability or low proficiency in properly handling the attributes along the road segment, low numbers of disengagements may indicate an ability and/or proficiency in properly handling the attributes along the road segment), the number of safety-related issues (e.g., high numbers of safety-related issues may indicate an inability or low proficiency in properly handling the attributes along the road segment, low numbers of safety-related issues may indicate an ability and/or proficiency in properly handling the attributes along the road segment), the number of comfort-related issues (e.g., the number of hard braking instances, the number of jerky steering instances, etc.), the number of simulated collisions, the number of progress-related events, the number of stuck events (e.g., the vehicle becomes stuck within the environment), the number of divergences from the rules of the road (or environment), etc. In some examples, the expansion component may analyze such factors to determine a metric that represents how well the vehicle is able to navigate the road segments within the cluster. In this example, a high metric value may represent a high proficiency in properly handling the attributes along the road segment whereas a low metric value may represent a low proficiency in properly handling the attributes along the road segments.

In some examples, the expansion component may determine a cost of modifying the software and/or hardware of the vehicle to improve the metric (e.g., increase the metric value). That is, in some cases, the metric may be below a threshold value which may indicate a difficulty in autonomously navigating the attributes of the road segments. In such cases, the expansion component may determine a cost that represents the cost for modifying the hardware and/or software of the vehicle such that, when navigated with the modified software and/or hardware, the metric increases to a value that meets or exceeds the threshold. The expansion component may determine the cost by identifying the factors (or events) that caused the metric to be below the threshold (e.g., large numbers of disengagements, comfort-related issues, etc.). Based on identifying such data, the expansion component or one or more users may predict an amount of time to modify the hardware and/or software (which may be based on the number of users needed) to resolve the factors (or events). In some cases, the higher the amount of time to fix the factors, the higher the cost. In contrast, the lower the amount of time to fix the factors, the lower the cost.

In some examples, the expansion component may determine an operating area based on the cost and/or the metric. An operating area may be a region (or geofence) of the environment within which a vehicle or fleet of vehicle(s) operate. The expansion component may determine the operating area by including clusters of road segments in the operating area. A cluster of road segment(s) may be included in the operating area based on the metric of the cluster meeting or exceeding the threshold value, the cost being below a threshold level, the number of road segments in a cluster meeting or exceeding a threshold number, etc.

In some examples, the expansion component may transmit the operating area to a vehicle or fleet of vehicles. That is, the expansion component may send the operating area to one or more vehicles in the environment. In such examples, the vehicle(s) may be controlled based on the road segments that are included in the operating area.

Additionally or alternatively, the expansion component may compare metrics of different clusters and/or discretized regions to determine operating regions. For example, the expansion component may determine a difference between clusters and/or road segments by comparing the metrics determined for such clusters and/or metrics. In this case, a high difference may indicate a low level of similarity (or a low similarity score), whereas a low difference may indicate a high level of similarity (or a high similarity score). Accordingly, in situations in which there is a low difference, the expansion component may cause the discretized region or cluster to be included in the cluster of discretized regions already included in the operating area.

The techniques described herein can improve the functioning, safety, and efficiency of autonomous and semi-autonomous vehicles operating in various driving environments. Utilizing clustered road segments to determine when and/or where to expand vehicle or fleet operating area(s) may increase the efficiency of the vehicles operating therein which may lead to an increased user experience. That is, the clustered road segments may be analyzed which may indicate which road segments the vehicle can navigate which may result in the vehicle getting stuck less, increasing progress along a route, increasing comfort for vehicle occupant(s), etc. Further, such techniques may increase operational efficiency by decreasing the amount or number of times that a remote operation system is requested by the vehicle, thereby reducing bandwidth consumed by communication systems. Further, the techniques described herein may increase the lifespan of the physical components on the vehicle since the operating area may be tailored to the capabilities of the vehicle, thereby ensuring that the operating area includes road segments that are within the capabilities of the vehicle systems.

The techniques described herein may be implemented in several ways. Example implementations are provided below with reference to the following figures. Although discussed in the context of an autonomous vehicle, the methods, apparatuses, and systems described herein may be applied to a variety of systems, and are not limited to autonomous vehicles. In another example, the techniques may be utilized in an aviation or nautical context, or in any other system. Additionally, the techniques described herein may be used with real data (e.g., captured using sensor(s)), simulated data (e.g., generated by a simulator), or any combination of the two.

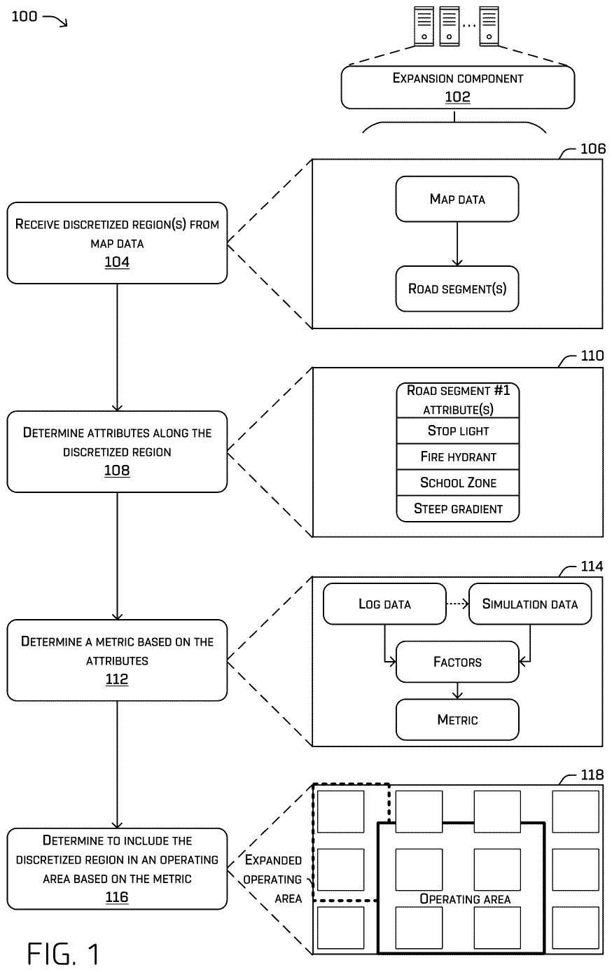

FIG. 1 is a pictorial flow diagram illustrating an example process 100 for expanding operating area(s) for a vehicle. As shown in this example, some or all of the operations in the example process 100 may be performed by an expansion component 102, a perception component, a prediction component, a planning component, and/or any other component or systems remote from, or within, an autonomous vehicle. For instance, as shown in this example, example process 100 may be implemented using an expansion component 102 that may be remote from the vehicle.

At operation 104, the expansion component 102 may receive discretized region(s) from map data. Map data may include data associated with static features or attributes in the environment. In some cases, the map data may include representations of the road network (e.g., road segment(s), lane segment(s), etc.) within the environment. The expansion component 102 may discretize the map data into one or more discretized regions. A discretized region may be a single road segment, a regularly spaced polygon, or an arbitrary region. For example, box 106 illustrates receiving road segment(s) from map data. In this example, box 106 includes a map data box which may include a representation of the environment. Further, box 106 may include a road segment box. The road segment box may represent some or all of the road segments within the map data. As noted above, the road segment(s) within the road segment box may represent the discretized regions of the map data.

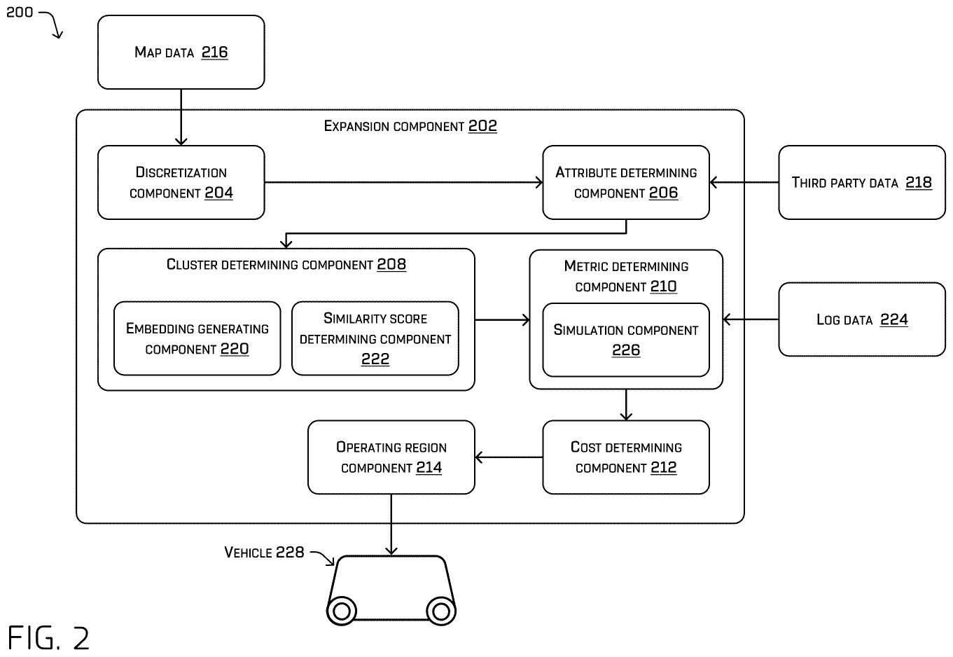

At operation 108, the expansion component 102 may determine attribute(s) along the road segment(s). In some examples, the attribute(s) may be features of the road segment that are located within, along, or on the side of the roadway. In some examples, attributes may include the presence of fire hydrants, school zones, emergency zones, steep gradients, traffic signage, traffic lights, crosswalks, junctions, etc. As noted above, the expansion component 102 may determine or identify the attributes located along the road segment based on using the annotations within the map data, using one or more machine-learned models trained to identify attributes along road segments, and/or by using third-party data. Additional detail regarding identifying attributes along a road segment may be described more in FIG. 2. In this example, box 110 illustrates attributes associated with a road segment. For example, box 110 includes a first road segment from the road segment box in box 106. Further, the table in box 110 includes the attributes that are associated with the first road segment. Such attributes may include the presence of (and/or number of) stop lights, fire hydrants, school zones, and/or steep gradients within the road segment.

At operation 112, the expansion component 102 may determine a metric associated with the road segment based on the attribute(s) determined at operation 108. The metric may represent the ability of a vehicle to autonomously navigate the road segment according to the attributes. In some examples, the expansion component 102 may determine the metric by analyzing simulation data of simulated log data. For instance, the expansion component 102 may receive log data (e.g., data (e.g., sensor data, prediction data, planning data, etc.) captured by vehicle(s) at a previous time), identify driving scenario(s) that include attributes similar to those in the road segment, simulate the driving scenarios, and/or analyze the simulation data to determine the metric.

For example, box 114 illustrates determining the metric from log and/or simulation data. In this example, the box 114 includes a log data box that includes driving scenarios with attributes similar to those in box 110. That is, the driving scenario(s) may include stop lights, fire hydrants, school zone(s), and/or steep gradients. As shown, the expansion component 102 may perform simulation operations on the driving scenarios which may result in simulation data (as shown by the simulation data box). In this example, the expansion component 102 may analyze the log data and/or the simulation data to determine the metric. For instance, the simulation and/or log data may include information regarding how the vehicle handled the attributes within the driving scenario. Such information may include the number of disengagements, the number of safety-related issues, the number of comfort-related issues (e.g., the number of hard braking instances, the number of jerky steering instances, etc.), the number of simulated collisions, the number of progress-related events, the number of stuck events (e.g., the vehicle becomes stuck within the environment), the number of divergences from the rules of the road (or environment), etc. These types of information may be the factors that are considered when determining the metric. The expansion component 102 may analyze such factors and determine a metric that is representative of how well the vehicle can autonomously navigate road segments with attributes similar to those in box 110.

Though not shown, the expansion component 102 may perform the techniques of operation 112 on clusters of road segments. That is, as described in FIG. 2, the expansion component 102 may cluster road segments based on similarity of attributes. In such cases, the expansion component 102 may determine the metric for the cluster.

At operation 116, the expansion component 102 may determine to include the discretized region in an operating area based on the metric. In some cases, the expansion component 102 may use the metric determined at operation 112 to determine an operation area for a vehicle. As noted above, an operation area may be a region of the environment within which a vehicle or fleet of vehicles are permitted to provide services (e.g., taxi services, delivery services, etc.). The expansion component 102 may include road segment(s) (e.g., discretized region(s)) in an operating area when the vehicle is capable of navigating the attributes within such road segments. As such, the expansion component 102 may analyze the metric determined at operation 112 to determine whether to include the road segment in the operating area. If the metric meets or exceeds a threshold value (e.g., the vehicle is capable of handling the attributes), the expansion component 102 may include the road segment in the operating area. If the metric is below a threshold value, the expansion component 102 may determine a cost that indicates the cost of modifying the vehicle software and/or hardware such that, when simulated on road segments with the attributes, the metric meets or exceeds the threshold. In such cases, if the cost is below a threshold level, the expansion component may include the road segment in the operating area. However, this example is not to be limiting; in other examples, the expansion component 102 may perform such operations on clusters of road segments. That is, the expansion component 102 may determine the cost for a cluster of road segments and determine whether to include the cluster of road segments in the operating area.

For example, box 118 illustrates a gridded road network. In this example, box 118 may include a solid-lined box that encompasses a portion of the gridded road network. The solid-lined box may represent the current operating area for a fleet of vehicles. As shown, the box 118 may also include a dashed lined polygon that represents the expanded operating area. The expanded operating area may be added to the current operating area. The expanded operating area may include road segments (or clusters of road segments) that were determined to be optimal to include in the operating area of a fleet of vehicles.

FIG. 2 illustrates an example computing system 200 including an expansion component 202 configured to determine expanded operating regions for a fleet of vehicles to operate within.

In some examples, the expansion component 202 may include various components, described below, configured to perform different functionalities of determining operating areas for fleets of vehicle(s). In some examples, some or all subcomponents of the expansion component 202 may be integrated in a remote server-based system while other subcomponents may be integrated in on-vehicle systems. In some examples, the expansion component 202 may include a discretization component 204 configured to generate discretized map data, an attribute determining component 206 configured to determine the attributes that are associated with discretized regions, a cluster determining component 208 configured to generate clusters of discretized region(s) based on the attribute(s) associated therewith, a metric determining component 210 configured to determine a metric for each cluster of road segment(s), a cost determining component 212 configured to determine a cost for modifying vehicle systems such that the metric is reduced, and/or an operating region component 214 configured to determine an operating region for vehicle(s) and/or fleets of vehicles.

In some examples, the expansion component 202 may receive map data 216. The expansion component 202 may receive map data of the region of the environment between the starting location of the vehicle and a destination. In some examples, the expansion component 202 may receive the map data 216 from an external map server, and/or may store the map data 216 in an internal storage. For instance, the autonomous vehicle may request a receive map data 216 from a remote map server, based on the destination to which the vehicle is to travel, and store one or more maps locally on the vehicle. In some examples, map data 216 can include any number of data structures, modeled in two or more dimensions that are capable of providing information about the environment, such as, but not limited to, road network data, topologies, intersections, streets, roads (e.g., road segments, lane segments), terrain, and the environment in general. The map data 216 may also represent various map features within the environment along the route, including but not limited to roads (or road segments), lanes, curbs, shoulders, crosswalks, buildings, junctions, crosswalks, keep clear zones, medians, street signs, traffic signs, speed limits, school zones, fire hydrants, emergency zones, etc. In some examples, the map data 216 may be sent to the discretization component 204 within the expansion component 202. Though shown that the discretization component 204 receives the map data 216, in other examples any other component of the expansion component 202 may receive the map data 216.

In some examples, the expansion component 202 may include a discretization component 204 configured to generate discretized map data. As shown, the discretization component 204 may receive the map data 216. The discretization component 204 may discretize the map data 216 into one or more subregions (e.g., discretized regions). In this example, a discretized region of the map data 216 may be a road segment. As described above, a road segment may be one or more driving lanes of equal length associated with the same direction of travel. As such, determining the discretized regions may include identifying the road segments within the map data 216.

In some examples, the expansion component 202 may include an attribute determining component 206 configured to determine the attributes that are associated with discretized regions. As shown the attribute determining component 206 may receive the discretized regions (e.g., the road segments) from the discretization component 204. The attribute determining component 206 may identify the attributes that are located within and/or along the road segment. As noted above, an attribute may include school zones, construction zones, steep gradients, fire hydrants, crosswalks, junctions, roundabouts, road surface types, etc.

In some examples, the attribute determining component 206 may determine the attributes using one or more different techniques. For example, such techniques may include analyzing the tags (e.g., labels, annotations, etc.) within the map data 216, utilizing machine-learned models to identify attributes, and/or leveraging third-party data 218. That is, in some cases, the map data 216 may include tags (e.g., labels, annotations, etc.) such that the attributes in the environment are tagged. As such, the attribute determining component 206 may identify the attributes by accessing the tags within the map data 216. Additionally or alternative, the attribute determining component 206 may determine the attributes by inputting the road segment into a machined-learned model trained to identify and/or output attributes within an environment. In such cases, the input may be the road segment and/or the map data 216. Additionally or alternatively, the attribute determining component 206 may identify the attributes by using third-party data 218 which may include city maps, organizational maps (e.g., hotel maps, hospital maps, etc.). In such cases, the attribute determining component 206 may analyze the third-party data 218 to determine which attributes are along the road segments.

In some examples, the expansion component 202 may include a cluster determining component 208 configured to generate clusters of discretized region(s) based on the attribute(s) associated therewith. The cluster determining component 208 may cluster the road segments based on similarity of attributes. That is, the cluster determining component 208 may identify road segments that have similar attributes and include such road segments in the same cluster. As shown, the cluster determining component 208 may include an embedding generating component 220 and a similarity score determining component 222. The embedding generating component 220 may be configured to generate embeddings of the road segment. In such cases, the embedding may include data associated with the attributes and/or features within and/or along the road segment. The similarity score determining component 222 may determine how similar the road segments are based on comparing the embeddings of such road segments. In such cases, the similarity score determining component 222 may subtract the values of the embeddings and cluster the road segments with the differences being below a threshold level.

In some examples, the expansion component 202 may include a metric determining component 210 configured to determine a metric for each cluster of road segment(s). The metric determining component 210 may receive log data 224. For example, one or more vehicles operating on various roadways in real-world conditions and environments may be in communication with the expansion component 202 implemented remotely from the vehicle. The vehicle may capture and provide log data 224 to the expansion component 202. As discussed above, the log data 224 may include, for example, image data, radar data, lidar data, time-of-flight data, and the like for various driving scenes encountered by the vehicle, as well as additional log data such as perception data (e.g., classification data, bounding boxes, etc.), prediction data (e.g., predicted trajectories of objects), trajectory information (e.g., candidate trajectories for the vehicle), and the like. Such a metric may further be based at least in part on a scenario (or associated embedding) most similar to the road segment, a metric associated with a representative embedding of a cluster of scenarios (e.g., mean, median, mode, etc. of all clusters), etc. As a non-limiting example, the metric for a new road segment may be the cost associated with a nearest embedding scaled by the cosine distance to the nearest embedding.

Vehicles may capture log data 224 while located in a variety of different driving environments. For instance, such driving environments may vary based on road geometry (e.g., T-intersection, three-way stop, straight road, curved road, etc.), a number of lanes, a type of lane marker (e.g., color of lane (e.g., yellow, white, etc.), dashed lane, solid single lane, solid double lane, etc.), a speed limit, a number of objects, a type of object (e.g., static, dynamic (e.g., vehicle (e.g., small car, semi-truck, etc.), pedestrian, animal, etc.), a feature of the object (e.g., a pose, a trajectory, a velocity, an acceleration, etc.), and/or any other factor. In some examples, the log data 224 may include one or more driving scenarios. A driving scenario may include the associated map data, vehicle information (e.g., trajectory data (e.g., velocity, acceleration steering angle, etc.), pose data, etc.), object information (e.g., a trajectory of the object(s), a pose of the object(s), a number of object(s), a type of the object(s) (e.g., vehicle (e.g., small car, semi-truck, etc.), pedestrian, animal, cyclist, etc.), a past trajectory of the object(s), etc.), speed limit data, a number of lanes, a type of lane marker, environmental data (e.g., time of day, visibility, amount of sunlight, weather conditions (e.g., rain, snow, ice, etc.), etc.) of the environment, a vehicle software version (e.g., software version the vehicle used when the data was captured), and/or any other information. Log data 224 may also include, without limitation, output of any one or more component (e.g., perception, prediction, planning, etc.), actuator messages, controller messages, or otherwise generated during or in response to the sensor data.

In some examples, the metric determining component 210 may include a simulation component 226 which may be configured to simulate driving scenarios (from the log data 224) that have similar attributes to those in the clusters of road segments. That is, the simulation component 226 may include a simulation system which may simulate driving scenarios. The result of the simulation may include simulation data that depicts the details regarding the simulation. In some cases, the metric determining component 210 may use the simulation data to determine the metric. For example, the metric may be determined based on one or more factors that are included in the simulation data. Such factors may include the number of disengagements (e.g., high numbers of disengagement may indicate an inability or low proficiency in properly handling the attributes along the road segment, low numbers of disengagements may indicate an ability and/or proficiency in properly handling the attributes along the road segment), the number of safety-related issues (e.g., high numbers of safety-related issues may indicate an inability or low proficiency in properly handling the attributes along the road segment, low numbers of safety-related issues may indicate an ability and/or proficiency in properly handling the attributes along the road segment), the number of comfort-related issues (e.g., the number of hard braking instances, the number of jerky steering instances, etc.), the number of simulated collisions, the number of progress-related events, the number of stuck events (e.g., the vehicle becomes stuck within the environment), the number of divergences from the rules of the road (or environment), etc. The metric may be sent to the cost determining component 212.

In some examples, the expansion component 202 may include a cost determining component 212 configured to determine a cost for modifying vehicle systems such that the metric is reduced. The cost may represent the cost for modifying the vehicle software and/or hardware such that when simulated, the metric may be satisfactory (e.g., meeting or exceeding a threshold level). The cost determining component 212 may determine the cost based on the metric being below a threshold level. Based on determining the cost, the cost determining component 212 may send the metric and/or the cost to the operating region component 214.

In some examples, the expansion component 202 may include an operating region component 214 configured to determine an operating region for vehicle(s) and/or fleets of vehicles. The operating region component 214 may analyze the cost and/or metric for the cluster(s) of road segment(s) and determine which cluster(s) to include in the operating region. In some examples, the operating region component 214 may include clusters in the operating region based on the cluster having a metric that meets or exceeds a threshold, a cost below a threshold, and/or above a threshold number of road segments. As shown, the operating region component 214 may send the operating area to one or more real-world vehicles 228 which may use the operating area data when determining where to navigate within an environment.

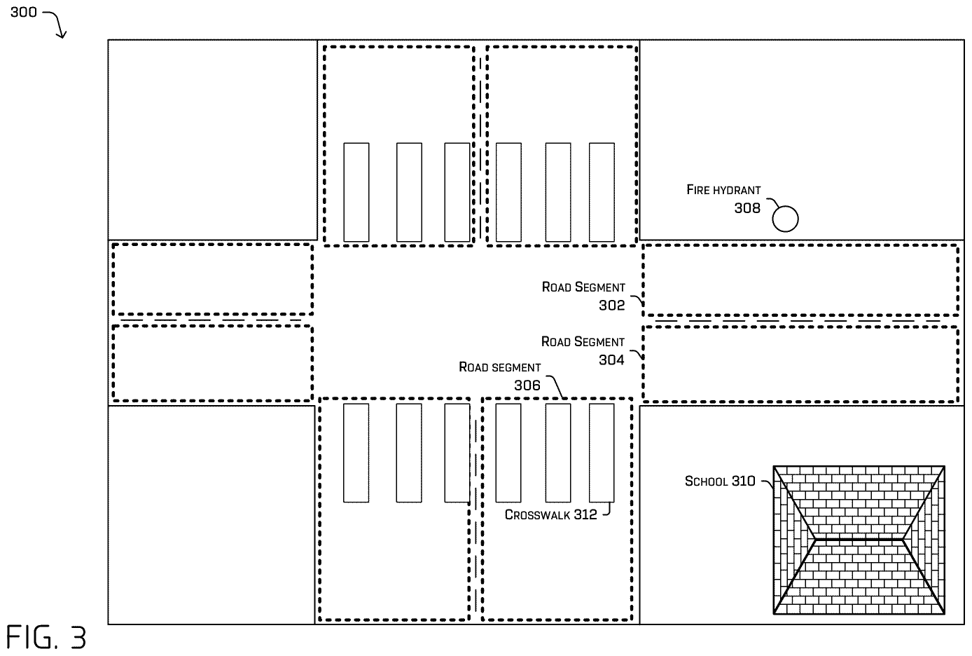

FIG. 3 depicts an example environment 300 including discretized regions of the environment with various attributes.

In this example, the example environment 300 may include a junction. The junction in FIG. 3 may be a four-way junction; however, in other examples, the junction may be a different type of junction. In this example, FIG. 3 may include road segments that outline one or more driving lanes of equal length and associated with the same direction of travel. As shown, FIG. 3 may include a road segment 302, a road segment 304, a road segment 306, and many others. In this example, the road segments may correspond to a single driving lane; however, in other examples, the road segments may correspond to more than one driving lane. Further, though the junction is not included in one of the road segments in FIG. 3, in other examples the junction may be a different discretized region or the junction may be included in one or more of the road segments.

In this example, the example environment 300 may also include various attributes. As shown, the attributes may include the junction, a fire hydrant 308, a school 310, and/or a crosswalk 312. As such in this example, the expansion component may determine that the junction, the crosswalk 312, and the school 310 are attributes of the road segment 306. Further, the expansion component may determine that the junction and the school 310 are attributes of the road segment 302. The expansion component may further determine that the junction and the fire hydrant 308 are attributes of the road segment 302. In some cases, the expansion component may use such data when determining the clusters and/or the metrics.

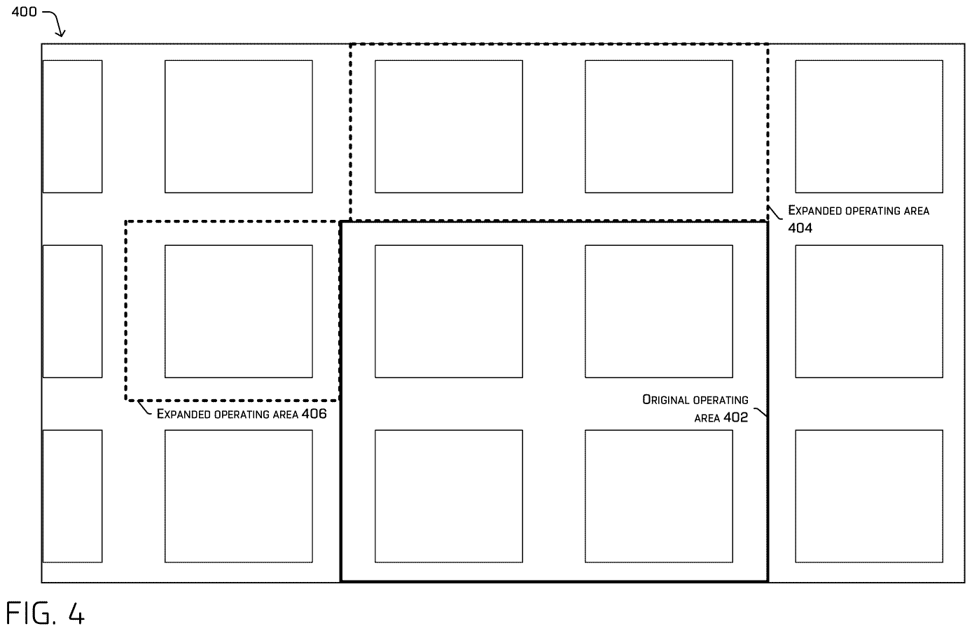

FIG. 4 depicts an example environment 400 including an operating region and/or expanded operating regions. Specifically, FIG. 4 illustrates expanding an original operating area to include additional road segments.

In this example, the example environment 400 may include a gridded roadway network. As shown, the example environment 400 may include a solid-lined polygon that represents the original operating area 402. The original operating area 402 may be the area of the environment in which the fleet of vehicles currently operate.

As shown, the example environment 400 may also include multiple dashed polygons that represent the expanded operating areas. That is, the example environment 400 may include a first expanded operating area 404 and a second expanded operating are 406. The expanded operating regions may be added to the original operating area 402. In this example, the expanded operating areas may include one or more road segments within which the fleet of vehicles may operate. As described above, the expanded operating areas may be determined based on the metrics and/or costs of the road segments and/or clusters.

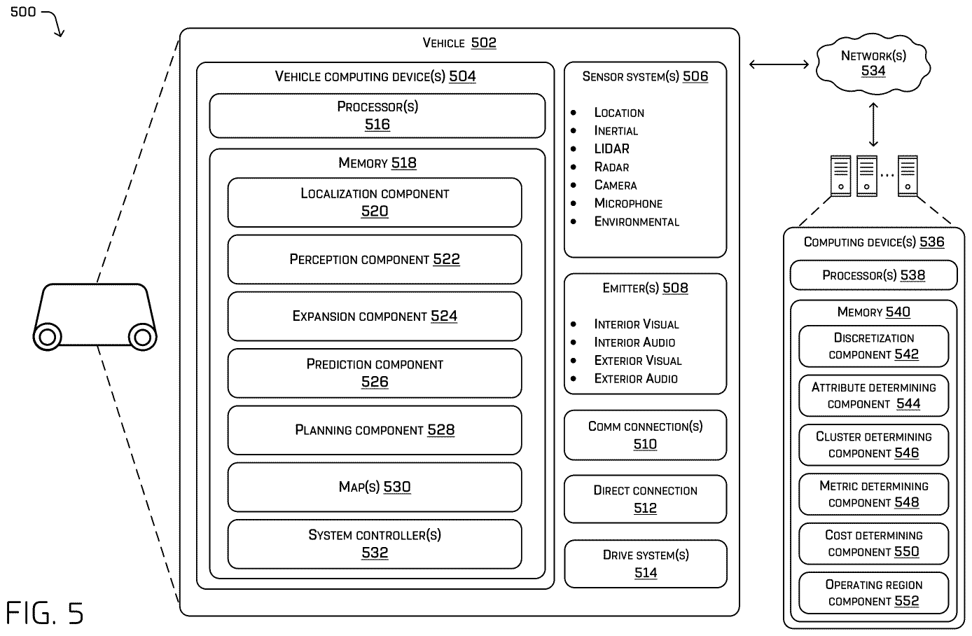

FIG. 5 is a block diagram of an example system 500 for implementing the techniques described herein. In at least one example, the system 500 may include a vehicle, such as vehicle 502. The vehicle 502 may include one or more vehicle computing devices 504, one or more sensor systems 506, one or more emitters 508, one or more communication connections 510, at least one direct connection 512, and one or more drive systems 514.

The vehicle computing device 504 may include one or more processors 516 and memory 518 communicatively coupled with the processor(s) 516. In the illustrated example, the vehicle 502 is an autonomous vehicle; however, the vehicle 502 could be any other type of vehicle, such as a semi-autonomous vehicle, or any other system having at least an image capture device (e.g., a camera-enabled smartphone). In some instances, the autonomous vehicle 502 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 502 may be a fully or partially autonomous vehicle having any other level or classification.

In the illustrated example, the memory 518 of the vehicle computing device 504 stores a localization component 520, a perception component 522, an expansion component 524, a prediction component 526, a planner component 528, one or more system controllers 532, and one or more maps 530 (or map data). Though depicted in FIG. 5 as residing in the memory 518 for illustrative purposes, it is contemplated that the localization component 520, the perception component 522, the expansion component 524, the prediction component 526, the planner component 528, system controller(s) 532, and/or the map(s) may additionally, or alternatively, be accessible to the vehicle 502 (e.g., stored on, or otherwise accessible by, memory remote from the vehicle 502, such as, for example, on memory 540 of one or more computing device 536 (e.g., a remote computing device)). In some examples, the memory 540 may include a discretization component 542, an attribute determining component 544, a cluster determining component 546, a metric determining component 548, a cost determining component 550, and/or an operating region component 552.

In at least one example, the localization component 520 may include functionality to receive sensor data from the sensor system(s) 506 to determine a position and/or orientation of the vehicle 502 (e.g., one or more of an x-, y-, z-position, roll, pitch, or yaw). For example, the localization component 520 may include and/or request/receive a map of an environment, such as from map(s) 530, and may continuously determine a location and/or orientation of the vehicle 502 within the environment. In some instances, the localization component 520 may utilize SLAM (simultaneous localization and mapping), CLAMS (calibration, localization and mapping, simultaneously), relative SLAM, bundle adjustment, non-linear least squares optimization, or the like to receive image data, lidar data, radar data, inertial measurement unit (IMU) data, GPS data, wheel encoder data, and the like to accurately determine a location of the vehicle 502. In some instances, the localization component 520 may provide data to various components of the vehicle 502 to determine an initial position of the vehicle 502 for determining the relevance of an object to the vehicle 502, as discussed herein.

In some instances, the perception component 522 may include functionality to perform object detection, segmentation, and/or classification. In some examples, the perception component 522 may provide processed sensor data that indicates a presence of an object (e.g., entity) that is proximate to the vehicle 502 and/or a classification of the object as an object type (e.g., car, pedestrian, cyclist, animal, building, tree, road surface, curb, sidewalk, unknown, etc.). In some examples, the perception component 522 may provide processed sensor data that indicates a presence of a stationary entity that is proximate to the vehicle 502 and/or a classification of the stationary entity as a type (e.g., building, tree, road surface, curb, sidewalk, unknown, etc.). In additional or alternative examples, the perception component 522 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

The expansion component 524 may perform any of the techniques described with respect to any of FIGS. 1-4 above with respect to determining regions of the environment to include in an expanded operating region for a fleet of vehicles.

The prediction component 526 may generate one or more probability maps representing prediction probabilities of possible locations of one or more objects in an environment. For example, the prediction component 526 may generate one or more probability maps for vehicles, pedestrians, animals, and the like within a threshold distance from the vehicle 502. In some instances, the prediction component 526 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

In some examples, the prediction component 526 may generate predicted trajectories of objects (e.g., objects) in an environment. For example, the prediction component 526 may generate one or more predicted trajectories for objects within a threshold distance from the vehicle 502. In some examples, the prediction component 526 may measure a trace of an object and generate a trajectory for the object based on observed and predicted behavior.

In general, the planner component 528 may determine a path for the vehicle 502 to follow to traverse through an environment. For example, the planner component 528 may determine various routes and trajectories and various levels of detail. For example, the planner component 528 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planner component 528 may generate an instruction for guiding the vehicle 502 along at least a portion of the route from the first location to the second location. In at least one example, the planner component 528 may determine how to guide the vehicle 502 from a first waypoint in the sequence of waypoints to a second waypoint in the sequence of waypoints. In some examples, the instruction may be a candidate trajectory, or a portion of a trajectory. In some examples, multiple trajectories may be substantially simultaneously generated (e.g., within technical tolerances) in accordance with a receding horizon technique. A single path of the multiple paths in a receding data horizon having the highest confidence level may be selected to operate the vehicle. In various examples, the planner component 528 may select a trajectory for the vehicle 502.

In other examples, the planner component 528 may alternatively, or additionally, use data from the localization component 520, the perception component 522, and/or the prediction component 526 to determine a path for the vehicle 502 to follow to traverse through an environment. For example, the planner component 528 may receive data (e.g., object data) from the localization component 520, the perception component 522, and/or the prediction component 526 regarding objects associated with an environment. In some examples, the planner component 528 receives data for relevant objects within the environment. Using this data, the planner component 528 may determine a route to travel from a first location (e.g., a current location) to a second location (e.g., a target location) to avoid objects in an environment. In at least some examples, such a planner component 528 may determine there is no such collision-free path and, in turn, provide a path that brings vehicle 502 to a safe stop avoiding all collisions and/or otherwise mitigating damage.

In at least one example, the vehicle computing device 504 may include one or more system controllers 532, which may be configured to control steering, propulsion, braking, safety, emitters, communication, and other systems of the vehicle 502. The system controller(s) 532 may communicate with and/or control corresponding systems of the drive system(s) 514 and/or other components of the vehicle 502.

The memory 518 may further include one or more maps 530 that may be used by the vehicle 502 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 502 may be controlled based at least in part on the map(s) 530. That is, the map(s) 530 may be used in connection with the localization component 520, the perception component 522, the expansion component 524, the prediction component 526, and/or the planner component 528 to determine a location of the vehicle 502, detect objects in an environment, generate routes, determine actions and/or trajectories to navigate within an environment.

In some examples, the one or more maps 530 may be stored on a remote computing device(s) (such as the computing device(s) 536) accessible via network(s) 534. In some examples, multiple maps 530 may be stored based on, for example, a characteristic (e.g., type of entity, time of day, day of week, season of the year, etc.). Storing multiple maps 530 may have similar memory requirements, but increase the speed at which data in a map may be accessed.

In some instances, aspects of some or all of the components discussed herein may include any models, techniques, and/or machine-learned techniques. For example, in some instances, the components in the memory 518 (and the memory 540, discussed below) may be implemented as a neural network.

As described herein, an exemplary neural network is a technique that passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833, which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

In at least one example, the sensor system(s) 506 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 506 may include multiple instances of each of these or other types of sensors. For instance, the lidar sensors may include individual lidar sensors located at the corners, front, back, sides, and/or top of the vehicle 502. As another example, the camera sensors may include multiple cameras disposed at various locations about the exterior and/or interior of the vehicle 502. The sensor system(s) 506 may provide input to the vehicle computing device 504. Additionally, or in the alternative, the sensor system(s) 506 may send sensor data, via the one or more networks 534, to the one or more computing device(s) 536 at a particular frequency, after a lapse of a predetermined period of time, in near real-time, etc.

The vehicle 502 may also include one or more emitters 508 for emitting light and/or sound. The emitter(s) 508 may include interior audio and visual emitters to communicate with passengers of the vehicle 502. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 508 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 502 may also include one or more communication connections 510 that enable communication between the vehicle 502 and one or more other local or remote computing device(s). For instance, the communication connection(s) 510 may facilitate communication with other local computing device(s) on the vehicle 502 and/or the drive system(s) 514. Also, the communication connection(s) 510 may allow the vehicle to communicate with other nearby computing device(s) (e.g., computing device 536, other nearby vehicles, etc.) and/or one or more remote sensor system(s) for receiving sensor data. The communications connection(s) 510 also enable the vehicle 502 to communicate with a remote teleoperations computing device or other remote services.

The communications connection(s) 510 may include physical and/or logical interfaces for connecting the vehicle computing device 504 to another computing device or a network, such as network(s) 534. For example, the communications connection(s) 510 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 502 may include one or more drive systems 514. In some examples, the vehicle 502 may have a single drive system 514. In at least one example, if the vehicle 502 has multiple drive systems 514, individual drive systems 514 may be positioned on opposite ends of the vehicle 502 (e.g., the front and the rear, etc.). In at least one example, the drive system(s) 514 may include one or more sensor systems to detect conditions of the drive system(s) 514 and/or the surroundings of the vehicle 502. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 514. In some cases, the sensor system(s) on the drive system(s) 514 may overlap or supplement corresponding systems of the vehicle 502 (e.g., sensor system(s) 506).

The drive system(s) 514 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 514 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 514. Furthermore, the drive system(s) 514 may also include one or more communication connection(s) that enable communication by the respective drive module with one or more other local or remote computing device(s).

In at least one example, the direct connection 512 may provide a physical interface to couple the one or more drive system(s) 514 with the body of the vehicle 502. For example, the direct connection 512 may allow the transfer of energy, fluids, air, data, etc. between the drive system(s) 514 and the vehicle. In some instances, the direct connection 512 may further releasably secure the drive system(s) 514 to the body of the vehicle 502.

In at least one example, the localization component 520, the perception component 522, the expansion component 524, the prediction component 526, the planner component 528, the one or more system controllers 532, and the one or more maps 530 may process sensor data, as described above, and may send their respective outputs, over the one or more network(s) 534, to the computing device(s) 536. In at least one example, the localization component 520, the perception component 522, the prediction component 526, the planner component 528, the one or more system controllers 532, and the one or more maps 530 may send their respective outputs to the computing device(s) 536 at a particular frequency, after a lapse of a predetermined period of time, in near real-time, etc.

In some examples, the vehicle 502 may send sensor data to the computing device(s) 536 via the network(s) 534. In some examples, the vehicle 502 may receive sensor data from the computing device(s) 536 and/or remote sensor system(s) via the network(s) 534. The sensor data may include raw sensor data and/or processed sensor data and/or representations of sensor data. In some examples, the sensor data (raw or processed) may be sent and/or received as one or more log files.

The computing device(s) 536 may include processor(s) 538 and a memory 540, which may include a discretization component 542, an attribute determining component 544, a cluster determining component 546, a metric determining component 548, a cost determining component 550, and/or an operating region component 552. In some examples, the memory 540 may store one or more of components that are similar to the component(s) stored in the memory 518 of the vehicle 502. In such examples, the computing device(s) 536 may be configured to perform one or more of the processes described herein with respect to the vehicle 502. In some examples, the discretization component 542, the attribute determining component 544, the cluster determining component 546, the metric determining component 548, the cost determining component 550, and/or the operating region component 552 may perform substantially similar functions as the expansion component 524.

The processor(s) 516 of the vehicle 502 and the processor(s) 538 of the computing device(s) 536 may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 518 and memory 540 are examples of non-transitory computer-readable media. The memory 518 and memory 540 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 5 is illustrated as a distributed system, in alternative examples, components of the vehicle 502 may be associated with the computing device(s) 536 and/or components of the computing device(s) 536 may be associated with the vehicle 502. That is, the vehicle 502 may perform one or more of the functions associated with the computing device(s) 536, and vice versa.

The methods described herein represent sequences of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes. In some examples, one or more operations of the method may be omitted entirely. For instance, the operations may include determining a first action and a second action by the vehicle relative to a selected trajectory without determining a respective cost for one or more of the actions by the vehicle. Moreover, the methods described herein may be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

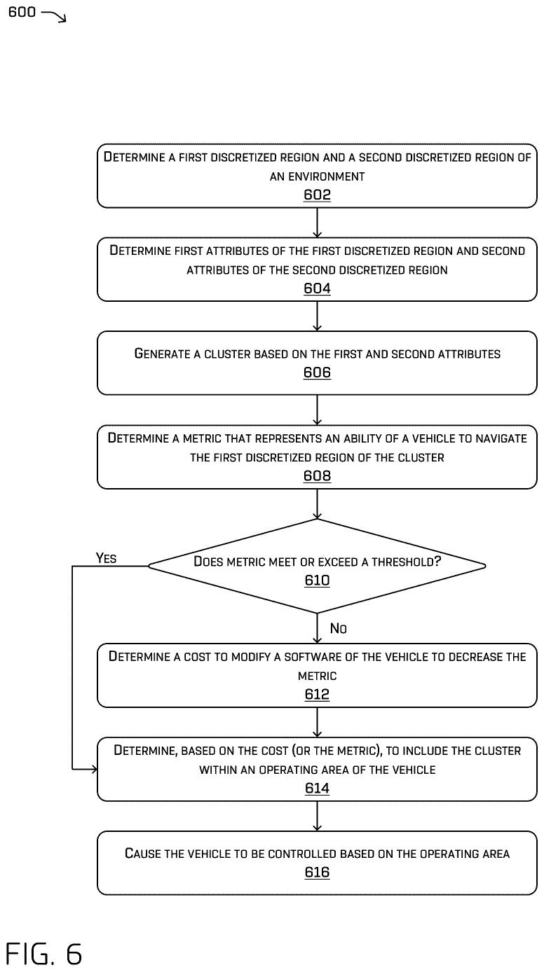

FIG. 6 is a flow diagram illustrating an example process 600 for receiving discretized regions of the environment, determining attributes of the discretized regions, determining a metric based on the attributes, determining a cost based on the metric, and determining an operating area based on the cost. As described below, the example process 600 may be performed by one or more computer computer-based components configured to implement or cause various functionalities described herein. For instance, process 600 may be performed by an expansion component 202. As described above, the expansion component 202 may be integrated as an on-vehicle system. However, in other examples, the expansion component 202 may be integrated as a separate server-based system.

Process 600 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 602, the expansion component 202 may determine a first discretized region and a second discretized region of an environment. In some examples, the expansion component may receive map data. Map data may include any number of data structures, modeled in two or more dimensions that are capable of providing information about the environment, such as, but not limited to, road network data, topologies, intersections, streets, roads, terrain, emergency zone(s), school zone(s), and the environment in general. The map data may also represent various map features within the environment along the route, including but not limited to roads (e.g., road segment data), lanes (e.g., lane segment data), curbs, shoulders, crosswalks, buildings, medians, street signs, traffic signs, speed limits, etc.

In some examples, the expansion component may generate discretized map data based on the map data. Discretized map data may include discretized or sectioned portions (or regions) of the environment. In some examples, a discretized region (or the discretized unit) may be a road segment (e.g., one or more driving lanes of equal length associated with the same direction of travel). That is, each road segment in the map data may be a discretized region. In some examples, a road segment (e.g., discretized region) may include one or more attributes (or environmental features) such as school zone(s), emergency zone(s) (e.g., hospitals, fire stations, etc.), steep gradient(s), roundabouts, fire hydrant(s), traffic light(s), etc.

At operation 604, the expansion component 202 may determine first attributes of the first discretized region and second attributes of the second discretized region. The expansion component may use various techniques to determine the attributes such as by manually analyzing the map data, by using machine-learned model(s) to output the attributes, and/or by using third-party data. That is, in some cases, the attributes may be labeled, tagged, and/or annotated in the map data. As such, the expansion component may identify the labeled attribute(s) in the map data that are located along the road segment(s). Additionally or alternatively, the expansion component may input the map data and/or the road segment into a machine-learned model which may be trained to identify the attributes along the road segments. In this case, the machine-learned model may output a list of the one or more attributes associated with a specific road segment. Additionally or alternatively, the expansion component may leverage third-party data such as city maps, organization maps, etc. to assist in identifying attribute(s) along the road segment.

At operation 606, the expansion component 202 may generate a cluster of road segments based on the first and second attributes. A cluster may include one or more road segments or discretized regions. The expansion component may determine the cluster(s) based on a similarity between the road segments. The similarity between road segments may be a similarity between attributes of the road segments. As an example, a first cluster may include road segments that have school zone(s), a second cluster may include road segments that have similar, steep gradients, etc. In some cases, the expansion component may determine the clusters using heuristic-based techniques and/or using machine-learned techniques. For example, the expansion component may generate an embedding associated with a road segment by inputting the road segment and the associated attribute(s) into a machine-learned model. An embedding may be a structured form of representing the road segment and the associating attributes. In this example, the expansion component may use the embeddings of the road segments to determine similarity between road segments. That is, the expansion component may compare embeddings (e.g., determine distances between values of the embeddings) to determine a similarity score between road segments and include road segments with threshold level similarity scores into the same cluster.

At operation 608, the expansion component 202 may determine a metric that represents an ability of a vehicle to navigate the first discretized region of the cluster. The metric may represent or measure the capability (or ability) of an autonomous vehicle to navigate a road segment within the cluster. That is, the metric may indicate the challenges of navigating the road segment autonomously based on the attributes associated with the road segment. In some examples, the expansion component may determine the metric by analyzing log data and/or simulation data.

For example, the expansion component may retrieve log data from a database. Log data may comprise, for example, sensor data acquired from one or more sensors, derivative data (e.g., perception data determined based on such sensor data), component status messages (e.g., battery state or charge, brake function, etc.), planner and control data, and any other message transmitted while the vehicle is in operation. Further, log data may include one or more driving scenarios captured and/or experienced by a vehicle at a previous time. A driving scenario may include the associated map data, vehicle (or vehicle representation) information (e.g., trajectory data (e.g., velocity, acceleration, steering angle, etc.), pose data, etc.), object information (e.g., a trajectory of the object(s), a pose of the object(s), a number of object(s), a type of the object(s) (e.g., vehicle (e.g., small car, semi-truck, etc.), pedestrian, animal, cyclist, etc.), a past trajectory of the object(s), etc.), speed limit data, a number of lanes, a type of lane marker, environmental data (e.g., time of day, visibility, amount of sunlight, weather conditions (e.g., rain, snow, ice, etc.), etc.) of the environment, a vehicle software version (e.g., software version the vehicle used when the data was captured), sensor data (e.g., lidar data, radar data, image data, etc.) and/or the times at which such sensor data was captured, and/or any other information. The expansion component may identify driving scenarios from the log data that include road segments similar to those in the cluster (e.g., road segment including the same or similar attributes). Based on receiving the driving scenario, the expansion component may simulate (or perform a simulation operation on) the driving scenario. Based on the simulation, the expansion component may receive simulation data which may be data about the simulation. In some examples, the expansion component may analyze the simulation data to determine the metric.

For example, the expansion component may determine the metric based on the simulation data. The simulation data may include factors that may impact the metric. For example, factors may include the number of disengagements (e.g., high numbers of disengagement may indicate an inability or low proficiency in properly handling the attributes along the road segment, low numbers of disengagements may indicate an ability and/or proficiency in properly handling the attributes along the road segment), the number of safety-related issues (e.g., high numbers of safety-related issues may indicate an inability or low proficiency in properly handling the attributes along the road segment, low numbers of safety-related issues may indicate an ability and/or proficiency in properly handling the attributes along the road segment), the number of comfort-related issues (e.g., the number of hard braking instances, the number of jerky steering instances, etc.), the number of simulated collisions, the number of progress-related events, the number of stuck events (e.g., the vehicle becomes stuck within the environment), the number of divergences from the rules of the road (or environment), etc. In some examples, the expansion component may analyze such factors to determine a metric that represents how well the vehicle is able to navigate the road segments within the cluster. In this example, a high metric value may represent a high proficiency in properly handling the attributes along the road segment whereas a low metric value may represent a low proficiency in properly handling the attributes along the road segments.

At operation 610, the expansion component 202 may determine whether the metric meets or exceeds a threshold value. That is, if the metric meets or exceeds the threshold (610: Yes), the expansion component may proceed to operation 614 and generate an operating area including the cluster. In contrast, if the metric is below a threshold value (610: No), the expansion component may determine a cost of modifying the vehicle systems such as to increase the metric value. That is, at operation 612, the expansion component 202 may determine a cost of modifying a software of the vehicle to increase the metric. That is, in some cases, the metric may be below a threshold value which may indicate a difficulty in autonomously navigating the attributes of the road segments. In such cases, the expansion component may determine a cost that represents the cost for modifying the hardware and/or software of the vehicle such that, when navigated with the modified software and/or hardware, the metric increases to a value that meets or exceeds the threshold.

At operation 614, the expansion component 202 may determine, based on the cost (or the metric), to include the cluster within an operating area of the vehicle. An operating area may be a region (or geofence) of the environment within which a vehicle or fleet of vehicle(s) operate. The expansion component may determine the operating area by including clusters of road segments in the operating area. A cluster of road segment(s) may be included in the operating area based on the metric of the cluster meeting or exceeding the threshold value, the cost being below a threshold level, the number of road segments in a cluster meeting or exceeding a threshold number, etc.

At operation 616, the expansion component 202 may cause the vehicle to be controlled based on the operating area. In some examples, the expansion component may transmit the operating area to a vehicle or fleet of vehicles. That is, the expansion component may send the operating area to one or more vehicles in the environment. In such examples, the vehicle(s) may be controlled based on the road segments that are included in the operating area.

### EXAMPLE CLAUSES

A: A system comprising: one or more processors; and one or more non-transitory computer-readable media storing computer-executable instructions that, when executed, cause the system to perform operations comprising: receiving, from a database, map data representative of an environment; determining, from the map data, discretized map data including a first discretized region and a second discretized region; determining first attributes associated with the first discretized region and second attributes associated with the second discretized region; determining, based at least in part on the first attributes, a first metric that represents a first ability of an autonomous vehicle to navigate the first discretized region; determining, based at least in part on the second attributes, a second metric that represents a second ability of the autonomous vehicle to navigate the second discretized region; determining a difference between the first metric and the second metric; determining, based at least in part on the difference, to include the first discretized region within an operating area of the autonomous vehicle; and causing the autonomous vehicle to be controlled based at least in part on the operating area.

B: The system of paragraph A, wherein determining the second attributes are associated with a cluster, and wherein determining the cluster comprises: receiving a plurality of attributes associated with a plurality of regions; determining, based at least in part on the plurality of attributes, a plurality of embeddings; and clustering, as the cluster, a set of the plurality of embeddings having a similarity score that meet or exceed a similarity threshold.

C: The system of paragraph A, further comprising: receiving log data associated with a driving scenario similar to the first discretized region; and performing a simulation on the driving scenario, wherein determining to include the first discretized region is further based at least in part on the simulation.

D: The system of paragraph A, wherein determining the first attributes comprises at least one of: receiving the first attributes from labeled data within the map data, receiving the first attributes from a machine-learned model trained to identify a plurality of attributes within the environment, or determining the first attributes from third-party data.

E: The system of paragraph A, wherein the first attributes or the second attributes include at least one of: driving lane data, parking space data, stop light data, fire hydrant data, emergency location data, gradient data, school zone data, or road data.

F: One or more non-transitory computer-readable media storing instructions executable by one or more processors, wherein the instructions, when executed, cause a system to perform operations comprising: determining first region of an environment; determining first attributes associated with the first region; determining, based at least in part on the first attributes, a metric that represents an ability of a vehicle to navigate the first region; determining, based at least in part on the metric, to include the first region within an operating area of the vehicle; and causing the vehicle to be controlled based at least in part on the operating area.

G: The one or more non-transitory computer-readable media of paragraph F, wherein determining the metric is further based at least in part on: determining a second region of the environment; determining second attributes associated with the second region; and determining, based at least in part on the first attributes and the second attributes, a similarity score between the first region and the second region.

H: The one or more non-transitory computer-readable media of paragraph F, wherein determining a cluster comprises: generating, based at least in part on the first attributes, a first embedding of the first region; determining a similarity score between the first embedding and a representative embedding of a cluster of embeddings; and determining the cluster based at least in part on the similarity score.

I: The one or more non-transitory computer-readable media of paragraph F, wherein determining the metric comprises: receiving log data associated with a driving scenario; performing a simulation on the driving scenario; and determining, based at least in part on the simulation, the metric.

J: The one or more non-transitory computer-readable media of paragraph I, wherein determining the metric is further based at least in part on: determining, based at least in part on the simulation, factors including at least one of: a number of disengagements, a number of simulated stuck events, a number of simulated collisions, a number of divergences from rules of the environment, a number of progress-related events, or a number of comfort-related events; determining, based at least in part on the factors, the metric.

K: The one or more non-transitory computer-readable media of paragraph F, wherein determining the first attributes comprises at least one of: receiving the first attributes from labeled data within map data, receiving the first attributes from a machine-learned model trained to identify attributes within the environment, or determining the first attributes from third-party data.

L: The one or more non-transitory computer-readable media of paragraph F, wherein the first attributes include at least one of: driving lane data, parking space data, stop light data, fire hydrant data, emergency location data, gradient data, school zone data, or road data.

M: The one or more non-transitory computer-readable media of paragraph F, the operations further comprising: determining a cost to modify software of the vehicle to increase the metric, wherein the cost is determined based at least in part on determining that the metric is below a threshold value.

N: The one or more non-transitory computer-readable media of paragraph F, wherein determining the first region comprises: receiving, from a database, map data that represents the environment; and determining, from the map data, discretized map data that includes the first region.

O: A method comprising: determining first region of an environment; determining first attributes associated with the first region; determining, based at least in part on the first attributes, a metric that represents an ability of a vehicle to navigate the first region; determining, based at least in part on the metric, to include the first region within an operating area of the vehicle; and causing the vehicle to be controlled based at least in part on the operating area.

P: The method of paragraph O, wherein determining the metric is further based at least in part on: determining a second region of the environment; determining second attributes associated with the second region; and determining, based at least in part on the first attributes and the second attributes, a similarity score between the first region and the second region.

Q: The method of paragraph O, wherein determining the metric comprises: generating, based at least in part on the first attributes, a first embedding of the first region; determining a similarity score between the first embedding and a representative embedding of a cluster of embeddings; and determining the metric based at least in part on the similarity score.

R: The method of paragraph O, wherein determining the metric comprises: receiving log data associated with a driving scenario; performing a simulation on the driving scenario; and determining, based at least in part on the simulation, the metric.

S: The method of paragraph R, wherein determining the metric is further based at least in part on: determining, based at least in part on the simulation, factors including at least one of: a number of disengagements, a number of simulated stuck events, a number of simulated collisions, a number of divergences from rules of the environment, a number of progress-related events, or a number of comfort-related events; determining, based at least in part on the factors, the metric.

T: The method of paragraph O, wherein determining the first attributes comprises at least one of: receiving the first attributes from labeled data within map data, receiving the first attributes from a machine-learned model trained to identify attributes within the environment, or determining the first attributes from third-party data.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving, from a database, map data representative of an environment;
determining, from the map data, discretized map data including a first discretized region and a second discretized region;
determining first attributes associated with the first discretized region and second attributes associated with the second discretized region;
determining, based at least in part on the first attributes, a first metric that represents a first ability of an autonomous vehicle to navigate the first discretized region;
determining, based at least in part on the second attributes, a second metric that represents a second ability of the autonomous vehicle to navigate the second discretized region;
determining a difference between the first metric and the second metric;
determining, based at least in part on the difference, to include the first discretized region within an operating area of the autonomous vehicle; and
causing the autonomous vehicle to be controlled based at least in part on the operating area.

2. The system of claim 1, wherein determining the second attributes are associated with a cluster, and wherein determining the cluster comprises:
receiving a plurality of attributes associated with a plurality of regions;
determining, based at least in part on the plurality of attributes, a plurality of embeddings; and
clustering, as the cluster, a set of the plurality of embeddings having a similarity score that meet or exceed a similarity threshold.

3. The system of claim 1, further comprising:
receiving log data associated with a driving scenario similar to the first discretized region; and
performing a simulation on the driving scenario,
wherein determining to include the first discretized region is further based at least in part on the simulation.

4. The system of claim 1, wherein determining the first attributes comprises at least one of:
receiving the first attributes from labeled data within the map data,
receiving the first attributes from a machine-learned model trained to identify a plurality of attributes within the environment, or
determining the first attributes from third-party data.

5. The system of claim 1, wherein the first attributes or the second attributes include at least one of:
driving lane data,
parking space data,
stop light data,
fire hydrant data,
emergency location data,
gradient data,
school zone data, or
road data.

6. One or more non-transitory computer-readable media storing instructions executable by one or more processors, wherein the instructions, when executed, cause a system to perform operations comprising:
determining first region of an environment;
determining first attributes associated with the first region;
determining, based at least in part on the first attributes, a metric that represents an ability of a vehicle to navigate the first region;
determining, based at least in part on the metric, to include the first region within an operating area of the vehicle; and
causing the vehicle to be controlled based at least in part on the operating area.

7. The one or more non-transitory computer-readable media of claim 6, wherein determining the metric is further based at least in part on:
determining a second region of the environment;
determining second attributes associated with the second region; and
determining, based at least in part on the first attributes and the second attributes, a similarity score between the first region and the second region.

8. The one or more non-transitory computer-readable media of claim 6, wherein determining a cluster comprises:
generating, based at least in part on the first attributes, a first embedding of the first region;
determining a similarity score between the first embedding and a representative embedding of a cluster of embeddings; and
determining the cluster based at least in part on the similarity score.

9. The one or more non-transitory computer-readable media of claim 6, wherein determining the metric comprises:
receiving log data associated with a driving scenario;
performing a simulation on the driving scenario; and
determining, based at least in part on the simulation, the metric.

10. The one or more non-transitory computer-readable media of claim 9, wherein determining the metric is further based at least in part on:
determining, based at least in part on the simulation, factors including at least one of:
a number of disengagements,
a number of simulated stuck events,
a number of simulated collisions,
a number of divergences from rules of the environment,
a number of progress-related events, or a number of comfort-related events;
determining, based at least in part on the factors, the metric.

11. The one or more non-transitory computer-readable media of claim 6, wherein determining the first attributes comprises at least one of:
receiving the first attributes from labeled data within map data,
receiving the first attributes from a machine-learned model trained to identify attributes within the environment, or
determining the first attributes from third-party data.

12. The one or more non-transitory computer-readable media of claim 6, wherein the first attributes include at least one of:
driving lane data,
parking space data,
stop light data,
fire hydrant data,
emergency location data,
gradient data,
school zone data, or
road data.

13. The one or more non-transitory computer-readable media of claim 6, the operations further comprising:
determining a cost to modify software of the vehicle to increase the metric, wherein the cost is determined based at least in part on determining that the metric is below a threshold value.

14. The one or more non-transitory computer-readable media of claim 6, wherein determining the first region comprises:
receiving, from a database, map data that represents the environment; and
determining, from the map data, discretized map data that includes the first region.

15. A method comprising:
determining first region of an environment;
determining first attributes associated with the first region;
determining, based at least in part on the first attributes, a metric that represents an ability of a vehicle to navigate the first region;
determining, based at least in part on the metric, to include the first region within an operating area of the vehicle; and
causing the vehicle to be controlled based at least in part on the operating area.

16. The method of claim 15, wherein determining the metric is further based at least in part on:
determining a second region of the environment;
determining second attributes associated with the second region; and
determining, based at least in part on the first attributes and the second attributes, a similarity score between the first region and the second region.

17. The method of claim 15, wherein determining the metric comprises:
generating, based at least in part on the first attributes, a first embedding of the first region;
determining a similarity score between the first embedding and a representative embedding of a cluster of embeddings; and
determining the metric based at least in part on the similarity score.

18. The method of claim 15, wherein determining the metric comprises:
receiving log data associated with a driving scenario;
performing a simulation on the driving scenario; and
determining, based at least in part on the simulation, the metric.

19. The method of claim 18, wherein determining the metric is further based at least in part on:
determining, based at least in part on the simulation, factors including at least one of:
a number of disengagements,
a number of simulated stuck events,
a number of simulated collisions,
a number of divergences from rules of the environment,
a number of progress-related events, or
a number of comfort-related events;
determining, based at least in part on the factors, the metric.

20. The method of claim 15, wherein determining the first attributes comprises at least one of:
receiving the first attributes from labeled data within map data,
receiving the first attributes from a machine-learned model trained to identify attributes within the environment, or
determining the first attributes from third-party data.
